(19) United States
(12) Patent Application Publication
(10) Pub. No.: US 2025/0034438 A1
(43) Pub. Date: Jan. 30, 2025

(54) COMPOSTABLE COLDSEAL COHESIVE

(71) Applicant: SUN CHEMICAL B.V., LV Weesp (NL)

(72) Inventors: Thierry FRINAULT, Rochdale, Greater Manchester (GB); Andrew MACDONALD, Rochdale, Greater Manchester (GB)

(73) Assignee: SUN CHEMICAL B.V., LV Weesp (NL)

(21) Appl. No.: 18/708,410

(22) PCT Filed: Jan. 19, 2023
(86) PCT No.: PCT/GB2023/050098

§ 371 Date: May 8, 2024

Related U.S. Application Data
(60) Provisional application No. 63/347,586, filed on Jun. 1, 2022.
(60) Provisional application No. 63/300,704, filed on Jan. 19, 2022.

(51) Int. Cl. C09J 7/38; B32B 27/10; B32B 27/32; B32B 37/12; B32B 37/24; B65D 65/46; C09J 5/00; C09J 7/21; C09J 7/24; C09J 7/29; C09J 11/08

(52) U.S. Cl. CPC C09J 7/383; B32B 27/10; B32B 27/32; B32B 37/12; B32B 37/24; B65D 65/466; C09J 5/00; C09J 7/21; C09J 7/243; C09J 7/29; C09J 11/08; B32B 2037/243; B32B 2255/10; B32B 2255/12; B32B 2255/26; B32B 2307/7163; B32B 2307/7376; B32B 2307/748; B32B 2439/00

(57) ABSTRACT

The present application describes a compostable cold seal cohesive composition. The present application also describes a packaging structure comprising the compostable coldseal cohesive composition of the invention.

### PRIORITY DOCUMENT

This application claims priority from US provisional application U.S. 63/300,704 and US provisional application U.S. 63/347,586, which are incorporated herein by reference.

### FIELD OF THE INVENTION

The present invention relates to coldseal cohesive compositions and their use in packaging applications, wherein the coldseal cohesive compositions comprise either low amounts, or are free of, non-biodegradable and non-compostable components.

### BACKGROUND

Coldseal is a water-based cohesive coating used to seal a variety of paper and film packaging materials. Coldseal is a self-seal adhesive only requiring pressure to seal. As the name implies, coldseal does not require heat. Coldseal cohesives are primarily used to seal heat-sensitive items like chocolate bars. The cohesive is typically applied wet to the substrate by a revolving gravure cylinder and immediately dried in an extended oven before it is reeled up at the end of the press.

Coldseal cohesive compositions known in the art typically comprise many non-biodegradable components, such as acrylic, styrene acrylics, and vinyl acetate emulsions. Thus, there is a need for new coldseal cohesive compositions that comprise low amounts of, or are free of, non-biodegradable and non-compostable components. The coldseal cohesive composition of the invention can thus be used in biodegradable packaging applications to afford products that undergo biodegradation and can be composted. New coldseal cohesive compositions must also satisfy the requirements for use, including suitably adhering to substrates and having suitable cohesive forces, in order to effectively seal packaging with the required sealing strength.

### SUMMARY OF THE INVENTION

The inventors have discovered a water-based coldseal cohesive composition that comprises low amounts of, or is free of, non-biodegradable and non-compostable components. The water-based coldseal cohesive compositions of the invention have suitable properties for effective use in sealing packaging. The inventors have thus found a way to replace the non-biodegradable and non-compostable components that are present in the coldseal compositions of the art, in a way that does not compromise performance.

In particular, the present invention provides a water-based coldseal cohesive composition comprising natural rubber latex, a biodegradable resinous material, and water. The invention further provides a structure comprising the composition of the invention as well as a packaged item comprising the structure of the invention. In addition, the invention provides a method of making the coldseal cohesive composition of the invention, as well as a method of making the structure of the invention. Finally, the invention provides for the use of the coldseal compositions of the invention for sealing packaging.

### DESCRIPTION OF THE INVENTION

### Definitions

Cohesive compositions are compositions that are capable of bonding to themselves, which can be used to join substrates together, such as packaging components. Cohesive compositions can be applied to the substrates of packaging components, which can be brought together and compressed in order to seal them together. Cohesive compositions bond to themselves, with the cohesive forces resisting separation. Cohesive compositions also act as adhesives and adhere to substrates, with the adhesive forces between the cohesive composition and the substrate also resisting separation.

Coldseal cohesives/adhesives are water-based natural rubber latexes primarily used to seal heat-sensitive items, such as chocolate bars. Coldseal is a self-seal adhesive that only requires pressure in order to seal (i.e., it does not require heat).

Unless otherwise stated, all ranges include the respective end points. For example, a range of between 3 and 9, includes the end points 3 and 9. However, where an end point is defined as being “more than” one value and/or up to “less than” another value, the range does not include the respective end points.

Unless otherwise stated, wt % (w/w) refers to the mass of the component in question in relation to all components present in the composition, including any solvents present.

Unless otherwise specified, method steps are intended to be performed in the order in which they are recited.

In the context of the present application, compostability refers to the ability of some materials to disintegrate within a specified timeframe under controlled conditions (see, ASTM D6400-19, point 6.2, ASTM D6868-19, point 6.2, and EN13432). Biodegradability refers to the conversion of organic carbon present in a sample into carbon dioxide under controlled conditions (see ASTM D6400-19, point 6.3, ASTM D6868-19, point 6.3, and EN13432). Where the compostability or biodegradability are defined in terms of a percentage, it is the percentage of the original material that is lost (either through sieving or as carbon dioxide) following the tests outlined in one of the above-mentioned standards. The percentage may not necessarily be compliant with the limit recited in the relevant test. Polymeric carbohydrates are carbohydrates that comprise at least 10 monosaccharide units in a chain.

Converters are companies that specialize in modifying or combining raw materials such as polyesters, adhesives, silicone, adhesive tapes, foams, plastics, felts, rubbers, liners and metals, as well as other materials, to create new products.

Directive (EU) 2018/852 is the last amendment of Directive 94/62/EC and contains updated measures designed to prevent the production of packaging waste, and promote the reuse, recycling and other forms of recovering of packaging waste, instead of its final disposal, thus contributing to the transition towards a circular economy.

### The Invention

Converters have expressed interest in a biodegradable or compostable coldseal adhesive. However, none are currently available on the market. Aside from the need for coldseal cohesives on heat-sensitive packaging items, converters in Europe would avoid taxation in 2030 by using a coldseal cohesive listed under European Waste “Directive (EU) 2018/852 Article 9 (5)”. The present application describes development of biodegradable and/or compostable coldseal cohesives with performance that is at least as good as currently available non-biodegradable and/or non-compostable products, when used on biodegradable and/or compostable substrates. Compostable packaging comprising the coldseal adhesive of the invention can be composted in a way that does not hinder composting activity.

The development approach comprises combining natural rubber latex (NRL) with other suitable biodegradable and/or compostable raw materials, for example proteins (e.g. casein, albumin, soy protein and soy protein isolate); and polymeric carbohydrates (e.g. starch, dextrin).

### Rubber

The coldseal cohesive composition of the invention comprises an NRL. The NRL for use in the invention maybe be water-based. Hevea brasiliensis is the major source of NRL but natural rubber is synthesized in over 2000 plant species and, for example, NRL produced by guayule (Parthenium argentatum Gray) or the Russian dandelion (Taraxacum koksaghyz), could be used within the scope of this invention.

### Biodegradable Resinous Material

It has surprisingly been found that biodegradable and/or compostable materials can be used to replace the non-biodegradable materials typically incorporated into coldseal compositions of the art, to provide compositions that have cohesive, adhesive, and blocking properties that are at least comparative with compositions of the art.

The biodegradable resinous material for use in the compositions of the invention is in the form of a resin (i.e., it is resinous). The biodegradable resinous material for use in the invention is preferably either a protein, a polymeric carbohydrate, or a combination thereof. The biodegradable resinous material for use in the invention is more preferably a protein selected from the group consisting of casein, albumin, whey protein, soy protein, soy protein isolate, and combinations thereof. The biodegradable resinous material for use in the invention is even more preferably casein and/or albumin.

The biodegradable resinous material for use in the invention may be a polymeric carbohydrates selected from the group consisting of starch, dextrin, cellulose, cyclodextrins, pectin, chitin, chitosan, hyaluronic acid, carrageenan gum, xanthan gum, and combinations therefore.

The biodegradable resinous material for use in the invention may be combination of two or more of the proteins and/or polymeric carbohydrates discussed above.

The biodegradable resinous material preferably imparts adhesion and anti-blocking properties to the formulation, properties that are normally achieved in non-biodegradable or non-compostable coldseal cohesives by combining NRL with various acrylic, styrene acrylics, vinyl acetate, or similar non-biodegradable and/or non-compostable emulsions.

### Biodegradability/Compostability

Packaging material is a finished product that can be considered compostable only if it's strictly compliant to certain criteria that ensures that the composting process will take place according to set rules and restrictions and in a controlled way, as opposed to a generic and uncontrolled biodegradation process. Specific regulations are in place in different regions. In general, the criteria are similar and stipulate that the compost produced is of good-quality and does not contain contaminants.

Packaging products include different constituents, which are classified as “components.” These include the substrate, inks, coldseals, adhesives and others. All components must comply with set rules. However, the complexity of these rules is a function of the components' maximum weight percentage in the packaging product. The substrate is normally the main component and the one that plays the most active part in the composting process. For this reason, compostable substrates are independently tested, not only for chemical composition and ecotoxicity, but also for biodegradation and disintegration, unlike components that don't exceed a certain weight percentage, as defined by the relevant standard.

According to the main international standards (i.e., ASTM 6400, ASTM D6868-19, EN13432), products applied at weight percentages higher than 1% would be considered package “constituents.” They would have to pass not only eco-toxicity and chemical analysis tests, but also the same biodegradation and disintegration tests required for the main packaging component, which is the actively compostable substrate.

Compostability is commonly measured according to the following standards: European EN 13432 (covering all packaging types), and the North American ASTM D6400-19 and D6868-19 standards (covering plastic and paper packaging products, respectively).

The European EN 13432 Standard has been adopted by many national standard bodies in many European Union member states. Key tests and pass/fail criteria are:
Disintegration—the packaging sample is mixed with organic waste and maintained under test scale composting conditions for 12 weeks, after which time no more than 10% of material fragments are allowed to be larger than 2 mm.
Biodegradability—a measure of the actual metabolic, microbial conversion under composting conditions of the packaging sample into water, carbon dioxide and new cell biomass. In industrial compostability conditions, within a maximum of six months (at 58° C.+2° C.), the biodegradation of the test sample must generate an amount of carbon dioxide that is at least 90% of the carbon dioxide given off from the control/reference material. In home compostability conditions biodegradation & disintegration testing are carried out at ambient temperature.
Low levels of heavy metals and potentially toxic elements, with adverse effect on the quality of compost produced—upper limits in mg/kg of dry sample are: zinc 150, copper 50, nickel 25, cadmium 0.5, lead 50, mercury 0.5, chromium 50, molybdenum 1, selenium 0.75, arsenic 5 and fluoride 100.
Ecotoxicity—The composted packaging material must not have adverse effect on selected plants growth through changes in the characteristics of the compost and soil contamination.

The North American ASTM D6400-19/D6868-19 Standards is similar to the EN 13432 Standard, but the NA ASTM D6400-19/D6868-19 Standards are also aimed at supporting the evidence that “the entire product or package will completely break down and return to nature within a reasonably short period of time after customary disposal,” which in this case is defined as 84 days for fragmentation of at least 90% of the product and 180 days for complete mineralization in a properly managed composting facility.

The main difference between ASTM D6400-19/D6868-19 and the EN13432 standard is that coatings/adhesives/coldseals and other components of the package with high application limits at a weight percentage between 1% and 10% require additional biodegradation tests in ASTM D6400-19/6868, wherein each component is tested individually.

The water-based coldseal cohesive compositions of the invention disintegrate under the conditions outlined in ASTM D6400-19, ASTM D6868-19, or EN13432 (see point 6.2) such that no more than 50% of its dry weight remains after sieving on a 2.0 mm sieve (i.e., the composition is compostable to ≥50%). The water-based coldseal cohesive compositions of the invention preferably disintegrate under the conditions outlined in ASTM D6400-19, ASTM D6868-19 (see point 6.2), or EN13432, such that no more than 30% of its dry weight remains after sieving on a 2.0 mm sieve (i.e., the composition is compostable to ≥70%), such as more preferably no more than 10% of its dry weight remains after sieving on a 2.0 mm sieve (i.e., the composition is compostable to ≥90%). In other words, the water-based coldseal cohesive compositions of the invention pass the test conditions outlined in either ASTM D6400-19 (point 6.2), ASTM D6868-19 (point 6.2), EN13432. The water-based coldseal cohesive compositions of the invention preferably pass the test conditions outlined in both ASTM D6400-19 (point 6.2) and ASTM D6868-19.

The water-based coldseal cohesive compositions of the invention may also biodegrade under the conditions outlined in either of ASTM D6400-19, ASTM D6868-19 (see point 6.3), or EN13432, such that at least 30% of the organic carbon present is converted to carbon dioxide (i.e. the composition is biodegradable to at least 30%). The water-based coldseal cohesive compositions of the invention preferably biodegrade under the conditions outlined in either of ASTM D6400-19, ASTM D6868-19, or EN13432 (see point 6.3) such that at least 50% of the organic carbon present is converted to carbon dioxide (i.e. the composition is biodegradable to at least 50%), such as more preferably at least 70% of the organic carbon present is converted to carbon dioxide (i.e. the composition is biodegradable to at least 70%). The water-based coldseal cohesive compositions of the invention may biodegrade under the conditions outlined in EN13432 and comply with this standard.

The water-based coldseal cohesive compositions of the invention may comply with at least one of ASTM D6400-19, ASTM D6868-19, and/or EN13432. The water-based coldseal cohesive compositions of the invention preferably comply with at least EN13432. The water-based coldseal cohesive compositions of the invention may comply with all of ASTM D6400-19, ASTM D6868-19, and EN13432.

### Additives

The coldseal cohesive compositions of the invention may further comprise one or more additives. The additives may be selected from the group consisting of anti-foaming agents, biocide agents, and combinations thereof.

### Amounts

### Biodegradable Resinous Material

As discussed, the biodegradable resinous materials are preferably solutions or dispersions of the biodegradable resinous materials in a solvent. The solvent is preferably water. The coldseal cohesive compositions of the invention preferably comprise between 10 and 70 wt % of a solution or dispersion of the one or more biodegradable resinous materials, such as between 10 and 60 wt %, and more preferably between 20 and 50 wt %, such between 30 and 50 wt % of a solution or dispersion of the one of more biodegradable resinous materials.

The biodegradable resinous solvents and dispersions preferably have a solids content of between 5 and 30 wt %, more preferably of between 7 and 20 wt %, and even more preferably of between 9 and 15 wt %, such as between 9 and 12 wt %. Accordingly, the coldseal cohesive compositions of the invention preferably comprise between 1 and 30 wt % of biodegradable resinous solids (e.g. casein and albumin), such as between 1 and 20 wt %, and more preferably between 2 and 15 wt %, such as between 2 and 10 wt %, and even more preferably between 2 and 8 wt % of biodegradable resinous solids (e.g. casein and albumin).

When the biodegradable resinous material is albumin, it is further preferred that the coldseal cohesive compositions of the invention comprise at least 2 wt % albumin solids, more preferably at least 3 wt % albumin solids, and even more preferably at least 4 wt % albumin solids. The coldseal cohesive compositions of the invention may comprise between 2 and 15 wt % albumin solids, such as between 3 and 15 wt % albumin solids, and more preferably between 3 and 10 wt %, and even more preferably between 4 wt % and 10 wt % albumin solids, such as between 4 and 8 wt % albumin solids.

### Natural Rubber

The coldseal cohesive compositions of the invention preferably comprise between 30 and 90 wt % of NRL, such as between 40 and 80 wt %, and more preferably between 45 and 70 wt %. The NRLs for use in the invention comprise natural rubber and water.

The NRL for use in the invention preferably has a solids content between 20 and 90 wt %, such as more preferably between 40 and 80 wt %, and most preferably between 50 and 70 wt %, such as around 60 wt %. Accordingly, the coldseal cohesive compositions of the invention preferably comprise between 10 and 70 wt % of natural rubber solids, such as between 15 and 60 wt %, more preferably between 20 and 50 wt % of natural rubber solids, and even more preferably between 25 wt % and 45 wt % of natural rubber solids, such as between 25 wt % and 36 wt % of natural rubber solids.

When the biodegradable resinous material comprises albumin, it is preferred that the coldseal cohesive composition comprises between 15 and 50 wt % natural rubber solids, more preferably between 15 and 40 wt % of natural rubber solids, and even more preferably between 20 wt % and 36 wt % of natural rubber solids.

### Non-Biodegradable/Non-Compostable Materials

The coldseal cohesive composition of the invention preferably comprises less than 50 wt % of non-compostable materials, such as less than 40 wt %, more preferably less than 30 wt %, such as less than 20 wt %, less than 10 wt %, and even more preferably less than 5 wt % of non-compostable materials. The coldseal cohesive composition of the invention may be free of non-compostable materials.

The coldseal cohesive composition of the invention preferably comprises less than 50 wt % of non-compostable materials, relative to the total solids content, such as less than 40 wt %, more preferably less than 30 wt %, such as less than 20 wt %, less than 10 wt %, and even more preferably less than 5 wt % of non-compostable materials relative to the total solids content.

The coldseal cohesive composition of the invention preferably comprises less than 70 wt % of non-biodegradable materials, such as less than 60 wt %, and more preferably less than 50 wt % of non-biodegradable materials.

Non-biodegradable or non-compostable materials are materials that are non-compliant with the following standards: EN 13432 (covering all packaging types), ASTM D6400-19 and D6868-19 (covering plastic and paper packaging products, respectively). In particular, non-compostable materials fail at least one of the relevant tests outlined in ASTM D6400-19 (point 6.2), ASTM D6868-19 (point 6.2) or EN13432. Non-biodegradable materials fail at least one of the relevant tests outlined in ASTM D6400-19 (point 6.3), ASTM D6868-19 (point 6.3) or EN13432. Examples of non-biodegradable and/or non-compostable materials include acrylics, styrene acrylics, shellac-modified polystyrene, ethylene vinyl acetate, styrene butadiene, vinyl acetate, and emulsions of any of the aforementioned.

### Ratio of Natural Rubber Solids to Biodegradable Resinous Material Solids

The coldseal cohesive composition of the invention preferably comprises natural rubber solids and biodegradable resinous material solids in a ratio of between 50:1 to 1:10, such as between 30:1 and 1:5. The coldseal cohesive composition of the invention more preferably comprises natural rubber solids and biodegradable resinous material solids in a ratio of between 20:1 to 1:1, such as between 20:1 and 2:1.

The coldseal cohesive composition of the invention even more preferably comprises natural rubber solids and biodegradable resinous material solids in a ratio of between 16:1 to 4:1.

### Water

The coldseal cohesive compositions of the invention preferably comprise water in an amount between 30 and 90 wt %, such as between 40 and 80 wt %, more preferably between 50 and 75 wt %, and even more preferably the coldseal cohesive compositions of the invention comprise water in an amount between 54 and 70 wt %.

### Total Solids Content

The coldseal cohesive composition of the invention preferably has a solids content between 10 and 60 wt %, such as between 20 and 50 wt %, or more preferably between 30 and 48 wt %.

### Additives

The coldseal cohesive composition of the invention may comprise one or more additives in an amount up to 10 wt %, such as up to 8 wt %, preferably up to 5 wt %, more preferably up to 3 wt %, and even more preferably up to 1 wt % of one or more additives.

### Exemplary Coldseal Adhesive Compositions of the Invention

The coldseal cohesive compositions of the invention may comprise between 1 and 15 wt % of biodegradable resinous solids (e.g. casein and/or albumin), between 10 wt % and 70 wt % of natural rubber solids, between 30 and 90 wt % water, and optionally up to 5 wt % of one or more additives. The coldseal cohesive compositions of the invention may comprise between 10 and 60 wt % solids. The coldseal cohesive compositions of the invention may comprise less than 30 wt % of non-biodegradable and non-compostable materials.

The coldseal cohesive compositions of the invention preferably comprise between 2 and 15 wt % of biodegradable resinous solids (e.g. casein and/or albumin), between 20 wt % and 50 wt % of natural rubber solids, between 50 and 75 wt % water, and optionally up to 3 wt % of one or more additives. The coldseal cohesive compositions of the invention preferably comprise between 20 and 50 wt % solids. The coldseal cohesive compositions of the invention preferably comprise less than 10 wt % of non-biodegradable and non-compostable materials.

The coldseal cohesive compositions of the invention more preferably comprise between 2 and 8 wt % of biodegradable resinous solids (e.g. casein and/or albumin), between 25 wt % and 45 wt % of natural rubber solids, between 54 and 70 wt % water, and optionally up to 1 wt % of one or more additives. The coldseal cohesive compositions of the invention more preferably comprise between 30 and 48 wt % solids. The coldseal cohesive composition of the invention more preferably comprise less than 5 wt % of non-biodegradable and non-compostable materials.

### Structures/Substrates

The invention further provides a structure comprising the coldseal cohesive composition of the invention on a substrate. The structure maybe a printed structure further comprising an additional printed layer on the substrate. Moreover, the coldseal cohesive composition of the invention may be printed onto the substrate. The structure of the invention may be a printed packaging structure, for example, for a food item.

The structure of the invention may comprise the coldseal cohesive composition of the invention coated onto the substrate at a dry coat weight of between 1 and 10 g/m², such as between 2 and 8 g/m², more preferably between 3 and 6 g/m², and even more preferably between 3 and 5 g/m². The coldseal cohesive composition of the invention may represent greater than 1 wt % of the total mass of the structure.

The substrate may have a thickness of between 10 and 100 μm, such as between 15 and 80 μm, preferably between 20 and 50 μm, and more preferably between 20 and 40 μm, such as between 23 and 35 μm.

The substrate may be a biodegradable substrate, including cellulose, polybutylene adipate terephthalate, polylactic acid, or a substrate derived from corn, sugar cane, or bamboo. Cellulose films may be derived from natural sources, including hemp, wood, and cotton.

When the substrate is compostable, the structure of the invention is compostable. For example, the structure of the invention disintegrates under the conditions outlined in ASTM D6400-19, point 6.2, ASTM D6868-19 point 6.2, or EN13432, such that no more than 50% of its dry weight remains after sieving on a 2.0 mm sieve (i.e., the structure is compostable to ≥50%). The structure of the invention preferably disintegrates under the conditions outlined in either of ASTM D6400-19, point 6.2, ASTM D6868-19, point 6.2, or EN13432, such that no more than 30% of its dry weight remains after sieving on a 2.0 mm sieve (i.e., the structure is compostable to ≥70%), such as more preferably no more than 10% of its dry weight remains after sieving on a 2.0 mm sieve (i.e., the structure is compostable to ≥90%). In other words, the structure of the invention passes the test conditions outlined in ASTM D6400-19 (point 6.2), ASTM D6868-19 (point 6.2), or EN13432. The structure of the invention preferably passes the test conditions outlined in both ASTM D6400-19 (point 6.2) and ASTM D6868-19 (point 6.2).

The structure of the invention may biodegrade under the conditions outlined in either of ASTM D6400-19, ASTM D6868-19, or EN13432 (see point 6.3) such that at least 30% of the organic carbon present in each individual component is converted to carbon dioxide (i.e. the printed substrate is biodegradable to at least 30%). The structure of the invention preferably biodegrades under the conditions outlined in either of ASTM D6400-19. ASTM D6868-19, or EN13432 (see point 6.3) such that at least 50% of the organic carbon present is converted to carbon dioxide (i.e. the printed substrate is biodegradable to at least 50%), such as more preferably at least 70% of the organic carbon present is converted to carbon dioxide (i.e. the printed substrate is biodegradable to at least 70%). The structure of the invention may biodegrade under the conditions outlined in EN13432 and complies with this standard.

While it is desirable to use the coldseal cohesive composition of the invention on compostable/biodegradable substrates, if required, the coldseal cohesive composition of the invention can also be used on non-compostable and/or non-biodegradable substrates, including polyolefins such as polyethylene, polytetrafluoroethylene, polypropylene, and polymethylpentene, polyesters such as polyethylene terephthalate (PET) and polybutylene terephthalate (PBT), polycarbonates, polystyrene, nylon, polyurethanes, and acrylics.

The invention also provides a packaged item comprising the structure of the invention. The structure of the invention thus forming the packaging for the item. The item can be a food item, such as a heat-sensitive food item including chocolate. The item can be a non-food, heat-sensitive item, such as a pharmaceutical item.

### Method of Making the Coldseal Cohesive Composition/Structure Comprising the Coldseal Cohesive Composition

The invention further provides a method of making the coldseal cohesive composition of the invention, comprising the steps of a) providing a natural rubber latex and a biodegradable resinous material; and b) mixing the natural rubber latex and the biodegradable resinous material in water to form the coldseal cohesive composition.

The invention also provides a method of making the structure or packaged item of the invention comprising the steps of a) providing the coldseal cohesive composition of the invention, and b) applying the coldseal cohesive composition to a substrate to make a coated substrate. The method may further comprise the steps of c) contacting the coated substrate with a second substrate, and d) applying pressure to the two substrates. The second substrate may also be coated with the coldseal cohesive composition of the invention. The step of applying the cohesive composition to a substrate may comprise printing the coldseal cohesive composition onto the substrate. Preferred methods include gravure and flexographic printing, with gravure most preferred.

The invention further provides the use of the coldseal cohesive composition of the invention for sealing packaging.

The present invention has been described in detail, including the preferred embodiments thereof. However, it will be appreciated that those skilled in the art, upon consideration of the present disclosure, may make modifications and/or improvements on this invention that fall within the scope and spirit of the invention.

### EXAMPLES

The invention is further described by the following non-limiting examples which further illustrate the invention, and are not intended, nor should they be interpreted to, limit the scope of the invention.

### Methods

Viscosity: Tested using the DIN4 viscosity cup at 20° C. Preferred viscosity is 15 s-25 s with DIN4 at 20° C.

T Peel Test: The composition of the invention are adjusted to print viscosity (18-20 s DIN4 @ 20° C.) with water and then printed onto ether a Natureflex™ NVS or Jindal OPPalyte™ MW247 substrate using a 12 μm red K-bar giving dry coat weights of 3.6-4.7 g/m² depending on the solid contents. Print samples are cut into 25 mm strips and sealed with a pressure of 276 kPa (40 psi) for 1 second using a RDM Pneumatic meshing twin crimp jaws sealing machine. Technical specification: Crimp jaws 1.8 mm pitch/1200 angle; area of jaws 150×25 mm. The seals are then separated in a T-peel at room temperature (20-21° C.) on a Lloyd Instruments LRX tensile tester at 150 mm/min; ensuring the “tail” is supported at an angle of 90° to the vertical. Results are expressed in N/25 mm. Target T-peel seal strength results: Preferably between 3.0-5.0 N/25 mm, and more preferably between 3.5-5.0 N/25 mm.

Adhesion Test: Approximately 100 mm of a 25 mm wide strip of Tesa 4104 adhesive tape with a 25 mm pre-folded end is carefully applied with firm finger pressure to the coldseal surface, ensuring no air bubbles are trapped. The structure is then separated in a T-peel test at room temperature (20-21° C.) on a Lloyd Instruments LRX tensile tester at 150 mm/min; ensuring the “tail” is supported at an angle of 90° to the vertical. The tape (pre-folded end) being in the top jaw; film and coldseal in the bottom jaw. Results are expressed in N/25 mm. Preferred adhesion result is ≥5 N/25 mm.

Blocking test: The samples are placed in a Specac press with platens having a diameter of 10 cm under 10 tons of pressure for 24 hours at room temperature (20-21° C.). 25 mm printed strips are cut from the samples and then separated in a T-peel test at room temperature (20-21° C.) on a Lloyd Instruments LRX tensile tester at 150 mm/min; ensuring the “tail” is supported at an angle of 90° to the vertical. Acceptable blocking is in the range of ≤0.5 N/25 mm with or without a compostable release lacquer applied on the opposite side to the coldseal.

Air Entrainment Foam Test: Performed at room temperature (20-21° C.). 100 ml of coldseal are placed in a 500 ml measuring cylinder with an internal diameter of 5 cm. Air bubbling is generated in the sample with an “aquarium pump” Interpet Aqua Air AP4 for 5 mins with the twin outlets combined to feed one porous stone (1.5 cm diameter, 2.5 cm length) placed at the bottom of the cylinder, the increase in volume is then recorded. Acceptable maximum increase 200 ml. The samples are then left to stand for 1 min and the new volume is recorded to assess reduction in foaming.

Field disintegration test (Compostability) in an industrial compostable facility: The substate Natureflex™ NVS film was coated with RESR736 on one side at 1.5 g dry/m² (100% coverage) and with the composition to be tested on the other side (4 g dry/m²; either 100% coverage or 50% coverage applied on the edges of the sheet of the substrate). Testing was then performed at the COMPOST MANUFACTURING ALLIANCE (CMA). Samples with 100% coverage were kept as sheets while samples with 50% coverage were cold-sealed as pouches with the inventive example 2 being the sealant and inside the pouches. The samples were tested according to ASTM D6400-19, point 6.2 and EN13432.

### Examples 1 to 3 and Comparative Example 4

TABLE 1
Composition of Inventive Examples 1-3

| Material | Inv. Ex. 1 | Inv. Ex. 2 | Inv. Ex. 3 |
|---|---|---|---|
| Thai Latex (NRL) | 69.625 | 59.625 | 49.625 |
| Picassian BI-001 (Casein | 30 | 40 | 50 |
| based dispersion) | | | |
| Xiameter AFE-1510 (Antifoam) | 0.125 | 0.125 | 0.125 |
| AF1324FG (Antifoam) | 0.125 | 0.125 | 0.125 |
| Proxel BD 20 (Biocide) | 0.125 | 0.125 | 0.125 |
| Total | 100 | 100 | 100 |
| Water (Viscosity fine-tuning) | 17.5 | 15 | 19 |
| Calculated Solids | 39.4 | 36.0 | 30.6 |

Examples were adjusted to print viscosity (18-20 s DIN4 @ 20° C.) with water and printed using a 12 μm red K-bar giving dry coat weights of 3.6-4.7 g/m² depending on the solid contents of the examples.

Comparative Example 4 is ADHC009 (also known as Polarseal S8044 CS) and is used as a reference. S8044 is a commercial, non-compostable, high-performance, natural rubber latex based coldseal from SunChemical, and is designed to give high-ranking results on a wide range of OPP films. S8044 has a solid content of 55% and a viscosity (DIN4 @ 20° C.) of 16.2 s. S8044 comprises around 40 wt % non-compostable material. S8044 was printed using an 8 μm Grey K-bar giving a dry coat weight of 4 g/m².

TABLE 2
T-peel Seal Strength Results (N/25 mm) on Natureflex ™
NVS & OPPalyte ™ MW247 substrates

| | | | MW247² | MW247 |
|---|---|---|---|---|
| Seal Strength | NVS¹ | NVS | Treated | Untreated |
| (N/25 mm) | Outside | Inside | Side | Side |
| Inv. Ex. 1 | 3.3 | 3.1 | 3.9 | 3.1 |
| Inv. Ex. 2 | 4.3 | 4.0 | 4.5 | 3.5 |
| Inv. Ex. 3 | 3.8 | 4.2 | 4.6 | 3.4 |
| Comp. Ex 4 S8044 | 3.8 | 3.4 | 4.0 | 4.9 |

¹Futamura Natureflex ™ NVS is a coldseal compatible compostable film based on cellulose. This substrate is certified as compostable in both industrial and home composting environments and is also suitable for anaerobic digestion. For testing purposes, tests were performed on both sides of the substrate (i.e. inside and outside surfaces). NatureFlex films are cellulose-based, derived from renewable wood pulp and certified to meet both the European EN13432 and American ASTM D6400-19 standards for compostable packaging. NatureFlex NVS is available in 23 and 30 micron thicknesses. The NVS film thickness tested was 23 micron.
²Jindal OPPalyte ™ MW247 is a white opaque uncoated biaxially oriented polypropylene film, which is print treated on one side and is especially designed for coldseal applications. This substrate is not compostable. Note that the work on this film was carried out for comparative purpose with the work carried out on the NVS film. MW247 with a thickness of 33 microns was used.

On treated MW247, Inventive Examples 1-3 all performed well, with seal strength being within the preferred range and similar to Comparative Example 4. On untreated MW247, Inventive Examples 1-3 all performed well, with seal strength being within the preferred range. Good seal strengths were obtained on NVS compostable film for all three Inventive Examples (similar to Comparative Example 4), with Inventive Example 2 being most preferred due to higher seal strengths and higher solid contents.

TABLE 3
Adhesion Results on NVS & MW247 (N/25 mm)

| Adhesion | NVS | NVS | MW247 | MW247 |
|---|---|---|---|---|
| (N/25 mm) | Outside | Inside | Treated | Untreated |
| Inv. Ex. 1 | 9.4 | 10.4 | 9.4 | 9.9 |
| Inv. Ex. 2 | 9.4 | 7.8 | 6.7 | 9.9 |
| Inv. Ex. 3 | 8.1 | 6.4 | 6.7 | 10.6 |
| Comp. Ex. 4 | 7.9 | 9.1 | 9.9 | 8.8 |

All three Inventive Examples exhibit good adhesion on both substrates (within the preferred range), similar to Comparative Example 4.

TABLE 4
Blocking test with no release lacquer on NVS & MW247

| | NVS | NVS | MW247 | MW247 |
|---|---|---|---|---|
| Example | Outside | Inside | Treated | Untreated |
| Inv. Ex. 1 | 0.21 | 0.19 | 3.13 | 3.01 |
| Inv. Ex. 2 | 0.04 | 0.09 | 3.53 | 1.48 |
| Inv. Ex. 3 | 0.05 | 0.04 | 2.72 | 0.49 |
| Comp. Ex. 4 | 1 | 1.2 | 2.2 | 2.3 |

Quite surprisingly, the inventive formulations release well from both sides of NVS compostable film without release lacquer with forces much lower than the acceptable limit of 0.5 N/25 mm. This means that the biodegradable or compostable coldseal could potentially be used in a laminate structure with NVS film reverse printed as the release film. This would be highly advantageous as the same coldseal could be used in monoweb and laminate applications.

Comparative Example 4 is normally used in combination with release lacquers and the high blocking values observed on both substrates were expected.

The inventive formulations did not produce the same acceptable blocking results on the MW247 standard film. Thus, if a user wanted to use the inventive biodegradable or compostable coldseal on a non-compostable OPP, the use of a release lacquer would likely be needed.

TABLE 5
Blocking with release lacquer

| Blocking with | NVS | NVS | MW247 | MW247 |
|---|---|---|---|---|
| RESR736 (N/25 mm) | Outside | Inside | Treated | Untreated |
| Ex.1 NRL:Pic 70:30 | 0.065 | 0.07 | 0.04 | 0.51 |
| Ex.2 NRL:Pic 60:40 | 0.045 | 0.075 | 0.035 | 0.085 |
| Comp. Ex 4 - S8044 | 0.07 | 0.07 | 0.12 | 0.17 |

SunChemical patented compostable release lacquer RESR736 was applied at a dry coat weight of 1.6 g/m² on the opposite side before applying the various coldseals. As expected, blocking is improved with the use of the compostable release lacquer RESR736 with samples showing virtually no blocking on both films. RESR736 is a solvent-based varnish based on a biodegradable compostable polyamide resin. The solids content of the varnish is 33-35%.

TABLE 6
Air Entrainment Foam Test

| | Inv. Ex. 1 | Inv. Ex. 2 | Inv. Ex. 3 |
|---|---|---|---|
| Time (mins) | Increase in Volume (ml) | | |
| 5 | 150 | 170 | 190 |
| 5 + 1 | 70 | 100 | 90 |
| min. rest | | | |

All three inventive examples performed within the preferred volume increase limit of 200 ml. Lower foaming is a preferred property as foaming on press in the duct or when the coldseal is pumped or goes through recirculation systems can negatively affect runnability and quality of the print.

After 1 minute of rest without air bubbled through the samples, all samples saw a considerable decrease in volume of foam. This is an important factor since if the configuration of the press generates foam in the coldseal, it would be desirable for the foam to dissipate as quickly as possible to avoid the problems previously mentioned.

Field disintegration testing in an industrial compostable facility was performed according to the method described above using inventive example 2 as the composition to be tested.

All samples meet ASTM D6400-19 and EN13432 criteria for compostability with a recovery of less than 5% within 50 days of active composting. In other words, all samples meet the criteria of point 6.2 of ASTMs D6400-19 and D6868-19, as well as the compostability test of EN13432.

### Performance Summary

The Inventive Examples all exhibit good seal strength on NVS and MW247 substrates.
The Inventive Examples all exhibit good adhesion on NVS and MW247 substrates.
The Inventive Examples all exhibit low blocking on NVS film with and without RESR736. Low blocking on the OPP film is seen with release lacquer.
All inventive examples passed the air entrainment foam test.
Natureflex™ NVS film coated RESR736 on one side and with inventive example 2 on the other side meet ASTM D6400-19 (point 6.2) and EN13432 and meet criteria for compostability.

### Inventive Examples 5-7

TABLE 7
Composition of examples 5 to 7

| Material | Inv. Ex. 5 | Inv. Ex. 6 | Inv. Ex. 7 |
|---|---|---|---|
| Thai Latex (NRL) | 70 | 60 | 50 |
| Langro Top A (Albumin | 30 | 40 | 50 |
| based solution) | | | |
| Xiameter AFE-1510 (Antifoam) | 0.125 | 0.125 | 0.125 |
| AF1324FG (Antifoam) | 0.125 | 0.125 | 0.125 |
| Proxel BD 20 (Biocide) | 0.125 | 0.125 | 0.125 |
| Total | 100 | 100 | 100 |
| Calculated Solids | 45.5 | 40.2 | 35.0 |

Examples 5 to 7 did not need viscosity adjustment with water and were printed using either a 12 or 8 μm K-bar giving dry coat weights of 3.6-4.7 g/m² depending on the solid contents of the examples.

TABLE 8
T-peel Seal Strength Results (N/25 mm) on Natureflex ™
NVS & Natureflex ™ NP substrates.

| Seal Strength | NVS | NVS | NP³ | NP |
|---|---|---|---|---|
| (N/25 mm) | Outside | Inside | Outside | Inside |
| Inv. Ex. 5 | 2.6 | 2.8 | 2.4 | 3.0 |
| Inv. Ex. 6 | 2.9 | 2.6 | 3.1 | 3.6 |
| Inv. Ex. 7 | 3.9 | 3.9 | 4.4 | 4.5 |

³Futamura Natureflex ™ NP is a film based on pure cellulose. This substrate is certified as compostable in both industrial and home composting environments and is also suitable for anaerobic digestion. Results are expressed in N/25 mm. Target T-peel seal strength results: Preferably 3.0-5.0 N/25 mm, more preferably 3.5-5.0 N/25 mm. Tests carried out as previously described. For testing purposes, tests were performed on both sides of the substrates (i.e. inside and outside surfaces).

On both substrates, Inventive example 7 performed well, with seal strength being within the preferred range and similar to Comparative Example 4. On the other hand, Inventive example 5 did not achieve the desired level of seal strength on both substrates while inventive example 6 did not achieve the desired level of bond strength on the NVS film (preferred film for coldseal applications) and narrowly gave an acceptable result on the NP film.

TABLE 9
Adhesion Results on Natureflex ™ NVS &
Natureflex ™ NP substrates.

| Adhesion | NVS | NVS | NP | NP |
|---|---|---|---|---|
| (N/25 mm) | Outside | Inside | Outside | Inside |
| Inv. Ex. 5 | 3.9 | 4.2 | 5.2 | 5.1 |
| Inv. Ex. 6 | 4.3 | 5.0 | 8.5 | 7.8 |
| Inv. Ex. 7 | 5.6 | 5.2 | 6.7 | 6.7 |

Results are expressed in N/25 mm. Adhesion Result Preferred is ≥5 N/25 mm. Tests carried out as previously described.

Inventive Example 7 exhibit good adhesion on both substrates (within the preferred range). Inventive Example 5 and 6 did not perform well on the NVS (preferred film for coldseal applications) but achieved good adhesion on the NP substrate.

TABLE 10
Blocking Results on NVS & NP for Inventive
example 7 with and without release lacquer.

| Blocking | NVS | NVS | NP | NP |
|---|---|---|---|---|
| (N/25 mm) | Outside | Inside | Outside | Inside |
| Inv. Ex. 7 & | 0.17 | 0.18 | 0.43 | 0.43 |
| no release | | | | |
| lacquer | | | | |
| Inv. Ex. 7 | 0.08 | 0.10 | 0.13 | 0.10 |
| with RESR | | | | |
| 736 | | | | |

Sun Chemical patented compostable release lacquer RESR736 was applied at a dry coat weight of 1.6 g/m² on the opposite side before applying the Inventive Example 7. Only Inventive example 7 was tested for blocking as it was the overall best performing system containing albumin. Tests carried out as previously described.

Quite surprisingly, the inventive formulation Example 7 release well from both sides of NVS and NP compostable film without release lacquer with forces lower than the acceptable limit of 0.5 N/25 mm. This means that the compostable coldseal could potentially be used in a laminate structure with NVS or NP films reverse printed as the release film. This would be highly advantageous as the same coldseal could be used in monoweb and laminate applications.

As expected, blocking is improved with the use of the compostable release lacquer RESR736 with samples showing virtually no blocking on both films.

### Performance Summary

The Inventive Example 7 exhibits good seal strength on NVS and NP substrates.
The Inventive Example 7 exhibits good adhesion on NVS and NP substrates.
The Inventive Example 7 exhibits low blocking on NVS and NP films with and without RESR736.
The Inventive Examples 5 and 6 showed deficiencies and would need further modifications to fit within the preferred ranges of performances.

TABLE 11
Inventive Examples 8-9.

| Material | Inv. Ex. 8 | Inv. Ex. 9 |
|---|---|---|
| Thai Latex (NRL) | 60 | 50 |
| CareTips 300D Solution | 40 | 50 |
| (12.9% solids) | | |
| Xiameter AFE-1510 (Antifoam) | 0.125 | 0.125 |
| AF1324FG (Antifoam) | 0.125 | 0.125 |
| Proxel BD 20 (Biocide) | 0.125 | 0.125 |
| Total | 100 | 100 |
| Water (Viscosity tunning) | 20 | 20 |
| Calculated Solids | 34.8 | 30.1 |

CareTips 300D, produced by Lactips, is the first natural pellet made of 100% biobased ingredients and is fully biodegradable. The pellets contain approximately 13-14% water. The 12.9% solids solution used in the inventive examples 8 and 9 was prepared by dissolving under moderate agitation at room temperature 15% by weight of the pellets in water containing 0.5% of Tego Foamex 1488 defoamer and 0.125% of Proxel BD 20 biocide.

Examples 8 and 9 were adjusted to print viscosity (18-20 s DIN4 @ 20° C.) with water and printed using a 12 μm red K-bar giving dry coat weights of 4.2 and 3.7 g/m² depending on the solid contents of the examples.

TABLE 12
T-peel Seal Strength Results (N/25 mm) on Natureflex ™
NVS & Natureflex ™ NP substrates.

| Seal Strength | NVS | NVS | NP | NP |
|---|---|---|---|---|
| (N/25 mm) | Outside | Inside | Outside | Inside |
| Inv. Ex. 8 | 4.1 | 4.2 | 5.2 | 5 |
| Inv. Ex. 9 | 4.7 | 4.4 | 6.2 | 6.4 |

Results are expressed in N/25 mm. Target T-peel seal strength results: Preferably 3.0-5.0 N/25 mm, more preferably 3.5-5.0 N/25 mm. Tests Carried out as previously described. On both substrates, Inventive Example 8 and 9 performed well, with seal strengths being within the preferred range or slightly greater for example 9 on Natureflex NP which is a favourable outcome.

TABLE 13
Adhesion Results on Natureflex ™ NVS &
Natureflex ™ NP substrates.

| .Adhesion | NVS | NVS | NP | NP |
|---|---|---|---|---|
| (N/25 mm) | Outside | Inside | Outside | Inside |
| Inv. Ex. 8 | 9.3 | 9.1 | 11 | 9.9 |
| Inv. Ex. 9 | 8.1 | 7.1 | 8.5 | 9.3 |

Results are expressed in N/25 mm. Adhesion Result Preferred is ≥5 N/25 mm. Tests carried out as previously described. Inventive Examples 8 and 9 exhibit good adhesion on both substrates (within the preferred range).

TABLE 14
Blocking with release lacquer

| Blocking with | NVS | NVS | NP | NP |
|---|---|---|---|---|
| RESR736 (N/25 mm) | Outside | Inside | Outside | Inside |
| Inv. Ex. 8 | 0.045 | 0.05 | 0.04 | 0.045 |
| Inv. Ex. 9 | 0.06 | 0.07 | 0.0 | 0.075 |

SunChemical patented compostable release lacquer RESR736 was applied at a dry coat weight of 1.6 g/m² on the opposite side before applying the coldseals. With the use of the compostable release lacquer RESR736, examples 8 and 9 show virtually no blocking on both films.

TABLE 15
Air Entrainment Foam Test carried out as previously described.

| | |
|---|---|
| Inv. Ex. 8 | Inv. Ex. 9 |

| | |
|---|---|
| Time (mins) | Increase in Volume (ml) |

| | | |
|---|---|---|
| 5 | 140 | 160 |
| 5 + 1 | 60 | 90 |
| min. rest | | |

Both Inventive Examples 8 and 9 performed within the preferred volume increase limit of 200 ml. Lower foaming is a preferred property as foaming on press in the duct or when the coldseal is pumped or goes through recirculation systems can negatively affect runnability and quality of the print.

After 1 minute of rest without air bubbled through the samples, both samples saw a considerable decrease in volume of foam. This is an important factor since if the configuration of the press generates foam in the coldseal, it would be desirable for the foam to dissipate as quickly as possible to avoid the problems previously mentioned.

### Performance Summary

The Inventive Examples 8 and 9 exhibit good seal strength on NVS and NP substrates.
The Inventive Examples 8 and 9 exhibit good adhesion on NVS and NP substrates.
The Inventive Examples 8 and 9 exhibit low blocking on NVS and NP film with RESR736.
Inventive examples 8 and 9 passed the air entrainment foam test.

The invention is further described by the following numbered paragraphs which form part of the description:
1. A water-based coldseal cohesive composition comprising;
   natural rubber latex;
   a biodegradable resinous material;
   and water;
   wherein, the printed coldseal adhesive applied at ≥1% of the weight of a biodegradable packaging structure doesn't prevent disintegration in a composting environment.
2. The composition of paragraph 1, wherein the dried composition is biodegradable at ≥50% absolute or relative to a reference.
3. The composition of paragraph 1, wherein the dried composition is biodegradable at ≥70% absolute or relative to a reference.
4. The composition of paragraph 1, wherein the dried composition is biodegradable at ≥90% absolute or relative to a reference.
5. The composition of paragraph 1, wherein the biodegradable resinous materials is selected from the group consisting of proteins, polymeric carbohydrates, and combinations thereof.
6. The composition of paragraph 1, wherein the biodegradable resinous materials is casein.
7. The composition of paragraph 1, wherein the biodegradable resinous materials is albumin.
8. The composition of any preceding paragraph, further comprising 1 or more additives.
9. The composition of paragraph 4, wherein the additives are selected from the group consisting of anti-foams and biocides.
10. The composition of any preceding paragraph, wherein the T-peel seal strength is in the range of 3.0-5.0 N/25 mm; more preferably 3.5-5.0 N/25 mm.
11. The composition of any preceding paragraph, wherein the adhesion is in the range of ≥5 N/25 mm.
12. The composition of any preceding paragraph, wherein the blocking is in the range of ≤0.5 N/25 mm with or without a compostable release lacquer applied on the opposite side to the coldseal.
13. The composition of paragraph 12, wherein the blocking is in the range of ≤0.5 N/25 mm with or without a compostable release lacquer applied on the opposite side to the coldseal upon aging.
14. The composition of any preceding paragraph, wherein the foaming is ≤200 ml.
15. The composition of any preceding paragraph, wherein the composition or structures containing the composition would pass field testing compostability protocol.
16. A printed structure comprising the composition of any one or more of paragraph 1-15.
17. The structure of paragraph 16, wherein the structure is a packaging structure.
18. The printed structure of paragraph 16 or 17, wherein the printed structure is compostable at >90%.
1. A water-based coldseal cohesive composition comprising;
   natural rubber latex;
   one or more compostable resinous materials;
   and water;
   wherein the composition is compostable.
2. The composition of paragraph 1, wherein the compostable resinous materials is selected from the group consisting of proteins, polymeric carbohydrates, long-chain hydroxy fatty acids and combinations thereof.
3. The composition of paragraph 1, wherein the compostable resinous materials is casein.
4. The composition of any preceding paragraph, further comprising 1 or more additives.
5. The composition of paragraph 4, wherein the additives are selected from the group consisting of anti-foams and biocides.
6. The composition of any preceding paragraph, wherein the T-peel seal strength is in the range of 3.0-5.0 N/25 mm; more preferably 3.5-5.0 N/25 mm.
7. The composition of any preceding paragraph, wherein the adhesion is in the range of ≥5 N/25 mm.
8. The composition of any preceding paragraph, wherein the blocking is in the range of ≤0.5 N/25 mm.
9. The composition of any preceding paragraph, wherein the foaming is ≤200 ml.

What is claimed:

1.-48. (canceled)

49. A structure comprising a water-based coldseal cohesive composition on a substrate;
wherein the water-based coldseal composition comprises;
(a) between 30 and 90 wt % of natural rubber latex;
(b) between 1 and 30 wt % of a biodegradable resinous material, wherein the wt % refers to the solids content of the biodegradable resinous material; wherein the biodegradable resinous material is a protein selected from the group consisting of casein, albumin, whey protein, soy protein, soy protein isolate, and combinations thereof, and wherein when the biodegradable resinous material is albumin, it is present in a solids content of at least 4 wt % relative to the total weight of the water-based coldseal cohesive composition; and
(c) between 30 and 90 wt % water;
wherein the substrate is selected from the group consisting of cellulose, polybutylene adipate terephthalate, polylactic acid, and combinations thereof;
wherein the coldseal cohesive composition is applied directly to the substrate; and
wherein the composition comprises less than 10 wt % of non-compostable material, wherein the non-compostable material is selected from the group consisting of acrylics, styrene acrylics, shellac-modified polystyrene, ethylene vinyl acetate, styrene butadiene, vinyl acetate, including emulsions thereof, and combinations thereof.

50. The structure of claim 49, wherein the biodegradable resinous material is casein.

51. The structure of claim 49, wherein the biodegradable resinous material is albumin.

52. The structure of claim 49, wherein the composition comprises less than 5 wt % of non-compostable material, and wherein the composition comprises between 1 and 20 wt % of the biodegradable resinous material.

53. The structure of claim 49, wherein the composition comprises between 40 and 80 wt % of the nature rubber latex, and wherein the natural rubber latex has a solids content between 20 and 90 wt %.

54. The structure of claim 49, wherein the composition comprises between 10 and 70 wt % of natural rubber solids, and wherein the composition comprises between 50 and 75 wt % water, and wherein the composition comprises a solids content of between 10 and 60 wt %.

55. The structure of claim 49, wherein the composition further comprises one or more additives selected from the group consisting of anti-foams, biocides, and combinations thereof.

56. The structure of claim 55, wherein the one or more additives are present in the composition in an amount of up to 10 wt %.

57. The structure of claim 49, wherein the structure is a packaging structure and wherein the structure is compostable to ≥90%.

58. The structure of claim 49, wherein the substrate is selected from substrates derived from corn, sugar cane, or bamboo, and combinations thereof.

59. The structure of claim 49, wherein the substrate is cellulose.

60. The structure of claim 49, wherein the substrate further comprises a printer layer.

61. A packaged item comprising the structure of claim 49.

62. The packaged item of claim 61, wherein the item is a food item.

63. The structure of claim 49, wherein the coldseal cohesive composition is coated on the substrate with a dry coat weight of between 1 and 10 g/m², and wherein the substrate has a thickness of between 20 and 50 μm.

64. The packaged item of claim 61, wherein the coldseal cohesive composition is coated on the substrate with a dry coat weight of between 1 and 10 g/m², and wherein the substrate has a thickness of between 20 and 50 μm.

65. A method of making the structure of claim 49, comprising the steps of:
(a) providing a water-based coldseal cohesive composition, wherein the water-based coldseal comprises:
(i) between 3 and 90 wt % of natural rubber latex;
(ii) between 1 and 30 wt % of a biodegradable resinous material, wherein the wt % refers to the solids content of the biodegradable resinous material; wherein the biodegradable resinous material is a protein selected from the group consisting of casein, albumin, whey protein, soy protein, soy protein isolate, and combinations thereof, and wherein when the biodegradable resinous material is albumin, it is present in a solids content of at least 4 wt % relative to the total weight of the water-based coldseal cohesive composition; and
(iii) between 30 and 90 wt % water;
(b) applying the coldseal cohesive composition to a substrate to make a coated substrate.

66. The method of claim 65, wherein the step of providing the coldseal cohesive composition comprises the steps of:
(a) providing a natural rubber latex and a biodegradable resinous material; and
(b) mixing the natural rubber latex and the biodegradable resinous material in water to form the coldseal cohesive composition.

67. The method of claim 65, further comprising the steps of:
(c) contacting the coated substrate with a second substrate; and then
(d) applying pressure to the substrates.

68. The method of claim 67, wherein before step (c), the second substrate is also coated with the coldseal cohesive composition.

69. The method of claim 65, wherein the step of applying the coldseal cohesive composition to a substrate comprises printing the coldseal cohesive composition onto the substrate.

70. A method for sealing packaging, wherein the packaging comprises the construct of claim 49, and a substrate selected from the group consisting of cellulose, polybutylene adipate terephthalate, polylactic acid, and combinations thereof; wherein the coldseal cohesive composition is applied directly to the substrate.
